(19) United States
(12) Patent Application Publication
(10) Pub. No.: US 2016/0109273 A1
(43) Pub. Date: Apr. 21, 2016

(54) Powder Dosing System

(71) Applicant: Mark LaFosse, San Diego, CA (US)

(72) Inventor: Mark LaFosse, San Diego, CA (US)

(21) Appl. No.: 14/918,434

(22) Filed: Oct. 20, 2015

Related U.S. Application Data
(60) Provisional application No. 62/065,881, filed on Oct. 20, 2014.

(51) Int. Cl. G01F 11/00; B65D 83/00; B65D 83/06

(52) U.S. Cl. CPC G01F 11/003; B65D 83/06; B65D 83/0005

(57) ABSTRACT

A portable storage and dispensing device is provided which, when actuated, measures portions from a reservoir of soluble powder and communicates those measured portions to a drinking vessel or container. The device includes a cannister having an interior cavity for positioning a powder reservoir which is dispensable using to a user-actuated measuring and dispensing component. A dispensing end of the cannister is adapted to deposit the powder in small-mouthed containers and concurrently avoid spillage.

This application is a U.S. Nonprovisional patent application of U.S. Provisional Patent Application Ser. No. 62/065,881 filed on Oct. 20, 2014, which is incorporated herein in its entirety by this reference thereto.

### FIELD OF THE INVENTION

The present device relates to portable storage and dispensing devices for mixing liquids with powdered concentrates, flavoring, or other soluble mixes which are measured for combination with a liquid. More particularly, the disclosed device, is configured for the storage, transport, and dosing of nutritional supplements and the like through the dispensing of measured volumes of powder into a beverage container, as well as providing an engageable user-accessible compartment which may be segmented to hold and sort additional pill and capsule supplements.

### BACKGROUND OF THE INVENTION

Currently, many exercise and nutrition supplements are sold in a powdered form such that a user can easily mix a specific or measured volume of the powdered product into a beverage of their choice for consumption. The range of current powdered supplements is broad and includes, for example, powdered supplement protein formulas for muscle builders and athletes, to baby formulas for nursing mothers to virtually any fluid-soluble edible substance which may be mixed with a liquid such as water or milk or other liquid mixtures adapted for mixing with powdered additives.

Although consumption of such powdered supplements which require measured volumes of the powder to be combined with the liquid when used in the home can be easily accomplished with cups or jars, and available measuring devices, many users, especially those who prefer to consume a supplement at a specific time of the day, prefer sealable portable bottles for carrying such ingestible liquid supplements. For example, many professional and amateur athletes consume protein formulas directly before their workout to maximize the efficiency and output of their effort, and may wish to ingest another such mixture afterwards.

Although many such powdered supplement and food products are packaged with measuring cups or spoons for proper measurement or dosing for the determined volume of liquid, the employment of such dispensing tools can be messy, prone to spills, and such are often imprecise. Such imprecision occurs due to powder-packing and spillage of excess powder beyond the edges of the measuring cup and can significantly vary the quantity and taste of the product dissolved in the liquid forming the drink.

Automatic measuring or dosing devices currently available in the art purport to solve the unmet need for a precise and clean dispensing system. However, such products are often designed for industrial use and are heavy and not particularly portable. Further, conventional measuring or dosing devices for mixing powders with liquids generally lack a means for dispensing carefully measured powder into the narrow openings of a bottle or drinking containers. Such results in powdered spillages and improperly mixed drinks.

As such there exists an unmet need for a lightweight and portable powder container for powder mixtures which must be measured accurately prior to being mixed with a liquid for ingestion by the user. Such a measuring or dosing device should be configured to accurately and easily dispense a volume of stored powder, into a bottle or container. Such a device should be configured to communicate the accurately measured dose of powder into a narrow opening of a beverage container without loss or spillage, and should do so hygienically. Because not all supplements ingested are provided in a soluble powder to be ingested as in liquid form, such a device should additionally include compartments for storing and carrying differing powdered products or supplements in pill or tablet form to allow the user to carry their nutritional products together. Finally, if the device functions as a reservoir for the powdered mix, such a device should be enabled with means to maintain the powder dry, to eliminate problems associated with moisture reaching a powder reservoir such as clumping, and mold growth for example.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of the present invention to provide a device capable of hygienic and secure storage of soluble nutritional supplements, drink flavoring, and other food adapted for ingestion while in a liquid, in a powder form.

It is an additional object of this invention to provide such a device which is further configured to measure and dispense an accurate or specific volume or dose of powder into a liquid container, during use.

It is another object of this invention for the device to provide removably engageable storage for other ingestible supplements in a separate storage compartment from the soluble powder.

These and other objects, features, and advantages of the present invention, as well as the advantages thereof over existing prior art, which will become apparent from the description to follow, are accomplished by the novel construction and improvements for a supplement carrying device described in this specification and hereinafter described in the following detailed description which fully discloses the invention, but which should not be considered as placing limitations thereon.

### SUMMARY OF THE INVENTION

In accordance with the purposes of the present invention, as embodied and broadly described herein, the present invention provides a soluble powder dispensing device configured in one preferred mode as a combination soluble powder and pill storage container and dispenser. In all modes of the device herein, it is preferred that the device provide an easy-actuated measuring and dispensing component to measure a volume of soluble powder and thereafter communicated the measured volume to a drinking vessel. In all modes herein, the powder volume measurement and dispensing actions can be accomplished using a hand activated actuator, which includes trigger operatively connected to an internal measuring component, for imparting motion thereto to first measure and then dispense the measured powder to a drinking vessel.

In one preferred mode, the device is configured such that powder is housed in a reservoir at a first end of the housing or cannister of the device. In another preferred mode of the device, the soluble power is provided from a supply of canisters where each canister is adapted for engagement with a first end of the housing of the device, to communicate a supply of soluble powdered material for measuring and dispensing. The housing or cannister of the device, which has a sidewall which defines an interior cavity or reservoir for powder storage, may also be surrounded by a silicone sleeve for increased user grip, durability, damage prevention, hygiene and aesthetics.

In manually activated modes of the device, an actuator to cause the dispensing chamber to measure and dispense the measured volume of powder, is provided by a depressable member or lever which is operatively engaged to or within the cannister, to project from a side surface of the sidewall of the device. Depression of the member or button by a user causes a dispensing chamber within the device to rotate about a central axis, or within a circular race, positioned within a central area of the canister. This rotation expels a measured volume or dose of soluble powder or other material, from a measuring chamber and to a dispensing tip adapted to communicate the dispensed powder to either a wide or narrow drinking vessel.

An optional storage compartment is adapted for engagement at the first or reservoir end of the cannister of the device. The storage compartment is configured to hold pills or other supplements or medications therein. So engaged, the storage compartment serves the dual functions of storing additional medications or supplements, and acting as a lid for the canister to maintain a powder supply within the reservoir of the device. Optionally a food-grade desiccant can be held within an aerated portion on an exterior wall of the storage compartment, to help maintain the powder stored in the device dry.

On the opposite end of the cannister of the device, a cap may be provided. The cap is adapted for positioning over a dispensing tip adapted for dispensing into narrow drinking vessels to protect it and keep it clean during transportation and storage.

The canister has a sidewall defining an overall cylindrical shape of the cannister at a first end. The sidewall defines an interior cavity which acts as a reservoir or powder container. One end of the formed powder reservoir, adjacent a mid portion of the cannister, narrows to direct and funnel powder held in the interior cavity, through an ingress slot and into the dosing chamber sized to preferably measure a volume of powder which may relate to a weight thereof. Preferably, the powder container, defined by the interior cavity, should be sized to hold between 5 and 20 cubic inches of soluble powder or other foodstuff to be mixed with an ingestible liquid.

The measuring chamber, preferably should be sized to intake a determined volume of powder from the reservoir or interior cavity, and communicate that volume of power in a subsequent dispensing to the drinking vessel. The measuring or dosing chamber is situated in a rotating measuring component which is actuated from a first position to receive a volume of powder from the interior cavity, to a second position wherein gravity causes the measured volume of powder to exit an internal measuring chamber and flow to a narrowed second or proximal end of the cannister. This second or proximal end of the canister may include threads or other complimentary fastener engagement thereon to fasten to the dispensing tip if employed. Such a complimentary fastener engagement, for example threads, will allow for a plurality of different tips to be engaged. Such complimentary fasteners can include slots, threads, clasps, press fits, frictional engagement, and slotted fins.

The canister defined by the sidewall, additionally includes an actuator aperture through which an actuator trigger or button or member, will project away from the exterior of the sidewall. The actuator may have this trigger or button engaged to an actuating member operatively engaged to rotate the measuring component with internal measuring chamber, between the first position wherein powder enters the measuring chamber, to a second position wherein that entry is blocked, and a second end of the measuring chamber is put into communication with a dispensing end of the device.

Actuators to rotate the measuring chamber can include a trigger rotationally engaged to translate a member or can include the trigger being translatable to rotate the housing containing the measuring chamber, or other means to move the housing having the internal measuring chamber from a first position wherein a first end is open for communication of powder from the reservoir or internal cavity, to a second position wherein communication with the interior cavity is blocked, and the measuring chamber is in communication at a second end with a pathway to dispense the powder to a drinking vessel.

If an onboard reservoir of powder is maintained in the interior cavity, graduation marks molded, painted or adhered to the canister can additionally be employed to provide the user with a visually discernable measurement of the internally stored volume of powder.

Sealing features within the canister may be operatively positioned at the distal end of powder container and at the egress slot to prevent powder loss as the dispensing chamber rotates. Additionally preferred, in all modes of the device, to maintain hygiene and render the device easy to hold and manipulate, a silicone sleeve may be included. The sleeve contoured to fit tightly around the exterior of the sidewall forming the canister, and additionally will include a viewing portal and an actuator portal to allow for the trigger and to view the contents.

In one mode of the device, the actuator, to move the measuring chamber between the first and second positions, is a rotationally engaged trigger which, when depressed, translates an arm rotationally engaged to a cylindrical member in which the measuring chamber is positioned. In another mode, the actuator may be a button having a contacting face and at least one gear rack engaged with a gear connected to the cylindrical member. In all modes, the actuator trigger or button is returned to a projecting position extending from the sidewall of the device by a biasing member such as a spring operatively engaged with either the translating member or the rotating member to bias them back to a projecting position.

The dispensing component of the device is cylindrical in shape or a cylindrical member and configured to rotate the dosing chamber as the cylindrical member rotates about a shaft or within a wall defining a circular race. This rotation between a first position and second position is imparted by the user activating the actuator by depressing the trigger or face of the translating member.

As noted, in a first position, a chamber inlet allows powder to fall under the force of gravity through the ingress slot in a mid section of the canister, from the reservoir or interior cavity, and to enter into the measuring chamber. Rotating the dispensing component or cylindrical member by employing the actuator, aligns an outlet slot with the egress slot wherein gravity will communicate the specific volume of powder, equal to the size of a measuring cavity of the dispensing component, to fall and exit at a second end of the canister.

The pill container, includes a pill cap and container base which interlock to both store additional pills and supplements and to seal the distal end of the canister. The pill container base should contain one or multiple o-rings, gaskets or alternative sealing fixtures to ensure an airtight fit against the inner cylindrical face and distal edge of the canister.

The pill container can additionally contain internal and removable cavities or separators to organize several different types of pills. Optional desiccants and labels within the pill container could ensure that its contents remain dry and identifiable.

The dispensing tip, is preferably curved and frusto conical in shape. This allows the user to communicate powder from the second end of the canister, into the drinking vessel of choice. The dispensing tip may be removably engageable using complimentary fasteners between the second end of the cannister and the dispensing tip such as threads on both, to tightly and securely mate to the matching threads of the canister.

A current preferred diameter of the dispensing tip aperture is between 0.25 and 3 inches which has been found in experimentation to control an orderly flow of powder into the drinking vessel over a few seconds, rather than have it all drop in at once which can cause problems with splashing, overflow and mixing. Additionally, it has been found that forming the dispensing tip in a curve away from a center axis of the cannister, has been show to help increase powder flow in this orderly fashion, prevent blockages, and preventing overly large volumes of the measured powder from communicating into the drinking vessel instantly. Finally, a funnel is designed with a distal end which fits within the proximal end of the canister for easy powder loading.

To employ the device herein, the user loads powder from an original package or container into the reservoir or interior cavity at the first end of the cannister of the device. If employed, the secondary or pill container may then placed securely on the filled canister, or just a cap may be placed thereon.

The user primes the device by holding it upright with the measuring chamber biased to the first position, by a biasing member such as a spring, and with the chamber inlet slot of the measuring chamber positioned to communicate powder from the reservoir or interior cavity under the force of gravity, through the ingress slot of the canister and into a defined measuring cavity of the cylindrical member housing the measuring cavity.

Pressing a trigger or button to activate the actuator, will cause the dispensing component or cylindrical member to rotate to a second position, wherein an outlet slot of the measuring cavity aligns with the egress slot of the canister. Gravity carries the powder from the measuring cavity and only the specific volume of powder, equal to the size of the measuring cavity, will fall into a properly positioned drinking vessel or container of choice.

In another preferred mode of the device, the housing or canister defined by the sidewall, may be shorter between the mid portion and first end, and thus does not have an internal cavity or reservoir to store powder. In this mode of the device, the first end of the cannister is adapted for engagement to one or a plurality of containers for commercially available products adapted for mixing with a liquid of choice. As such, in this mode of the device, the reservoir at the first or reservoir end of the cannister, is provided by the commercial container which is adapted for a removable engagement with the first end. This removable engagement may for example be a frictional engagement between one end of the commercial container and the first or reservoir end of the device herein, or a threaded engagement therebetween, or other removable engagement as would occur to those skilled in the art.

Additional device components in either preferred modes can be implemented as part of the dispensing mechanism for ease of use and to ensure product cleanliness and longevity including items in a list including but not limited to: o-rings, gaskets, bearings, brushes, linear slides, rods, or bushings. Some or all of the components of the device herein can be formed from one or a combination of food-safe durable materials from a group including plastic, rubber, silicone, glass, metals, ceramics, and polymeric materials.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other powder and pill storage and dispensing products for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion.

In the drawings:

FIG. 1 depicts a left side view of a first preferred mode of the device in an assembled configuration having a translatable member engaged with a gear providing the actuator to rotate the cylindrical member having the measuring cavity therein in a first position.

FIG. 2 displays a cross sectioned right view of the first preferred mode of the device shown in FIG. 1 and depicting the translating member and gear defining the actuator to rotate the cylindrical member between first and second positions.

FIG. 2a depicts a mode of the device similar to that of FIGS. 1-2 but wherein an actuator is a rotationally engaged trigger operatively connected to rotate the cylindrical member, and biased to a projecting position from the sidewall of the device.

FIG. 2b shows an enlargement of the actuator of FIG. 2A showing the trigger and engaged connecting member rotationally engaged between the trigger and the cylindrical member during actuation by a user and rotating the cylindrical member and measuring cavity from the first position toward the second position.

FIG. 3 depicts a section view of the device showing the internal cavity defined by the interior surface of the sidewall, and axis and cavity sized for rotational engagement of the cylindrical member.

FIG. 4 depicts an isometric view of a silicone sleeve component sized for engagement upon the exterior surface of the device herein.

FIG. 5 displays a view of an actuator formed as a translatable member having a gear rack engageable with a gear operatively attached to the circular member such as in FIG. 6.

FIG. 6 depicts a cross sectioned right view of the dispensing chamber for the powder stored in the sleeve-surrounded cannister.

FIG. 7 shows a perspective view of an engageable lid employable to cover the open end of the interior cavity.

FIG. 8 displays a side view of a removably engageable spill-preventing frusto conical dispensing tip adapted for dispensing powder within the circumferential edge of a glass or container.

FIG. 9 depicts a perspective view of a loading funnel employable for filling the reservoir or internal cavity defined by the sidewall of the cannister.

FIG. 10 represents a side view of the device having the distal or reservoir end of the cannister adapted for sealed removable engagement with a third party container.

FIG. 11 shows the optional secondary container formed as a segmented pill or tablet holder configured to be employed in place of the engageable lid of FIG. 7.

FIG. 12 depicts a perspective view of a perforated holding cavity adapted for positioning of a desiccant therein which may be engaged to either the lid of FIG. 7, or the secondary container of FIG. 11.

### DETAILED DESCRIPTION OF THE INVENTION

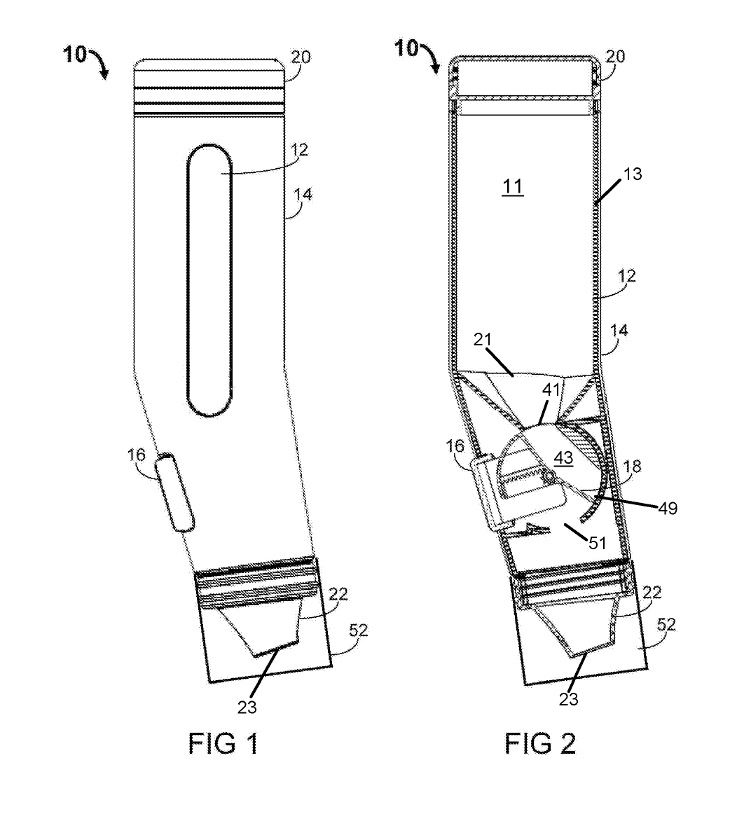

Now referring to drawings in FIGS. 1-12, wherein similar components are identified by like reference numerals, there is seen in FIG. 1, an exterior view of the device 10 configured in a preferred mode, assembled wherein powdered supplements may be stored within an internal cavity 11 at a first end of the canister 12. The cannister 12, formed by a sidewall 13, has external dimensions configured to allow positioning of the cannister 12, within an axial recess of a silicone sleeve 14.

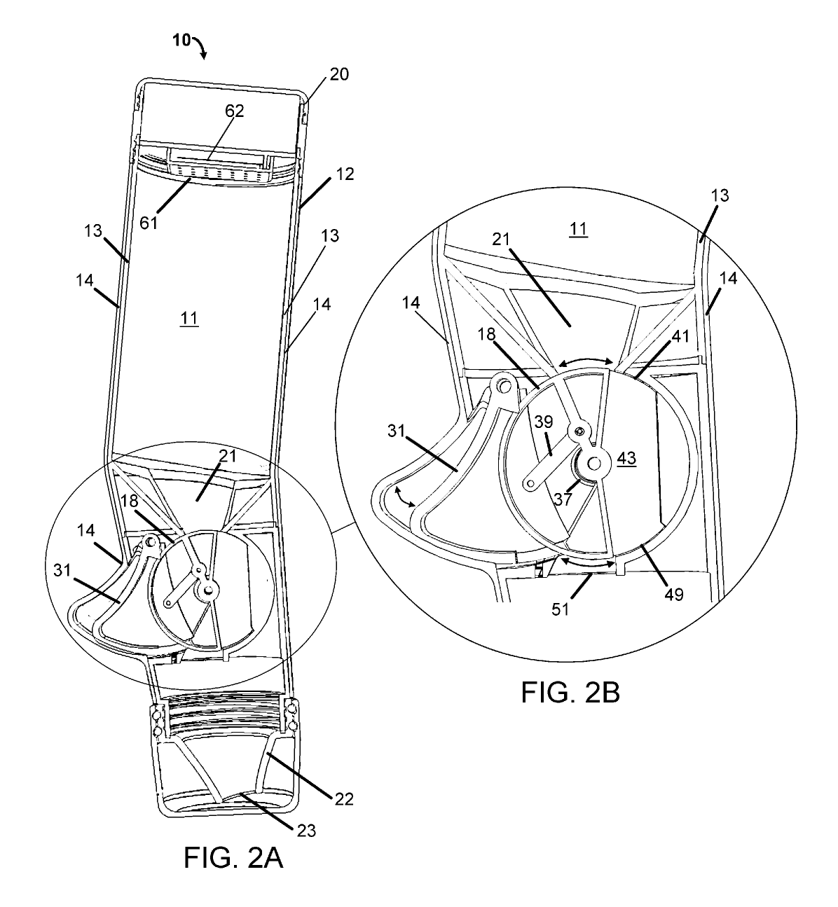

Shown in FIGS. 1-2, the device 10 has a canister 12 having the sidewall 13 defining an internal cavity 11 employable as a reservoir for supplement or other powder. The exterior of the device 10, in a particularly preferred mode, includes a silicone sleeve 14 sized to surround and protect the sidewall 13 and rest of the device 10 during use and transport. The silicone sleeve 14 is sufficiently elastic to be stretched and slid upon the exterior of the device 10, provides a compressible non-slip surface for enhancement of user grip on the assembled device 10 as well as enhancements to durability to protect the device 10 from drops and bumps and other potentially injurious contact.

An actuator is operatively engaged for user-activation to initiate the device 10 to dispense powder stored in the interior cavity 11, into a drinking vessel or other container. As shown in FIG. 2 this actuation can be initiated by the user through the depression of a spring biased button 16, which is biased to a default position projecting away from the sidewall 13, through an aperture 17 therein and through the sleeve 14 if employed.

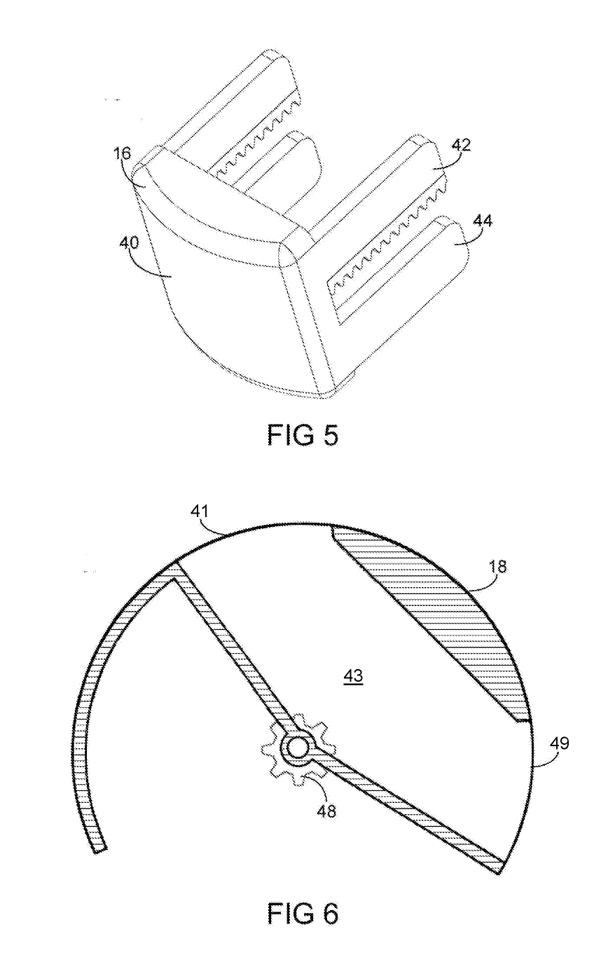

In this depicted mode of an actuator, depression of the button 16 toward the sidewall 13 translates geared members (FIG. 5) to rotate a dispensing housing 18 about a central axis within a central area of the canister 12 to move from a first position to a second or a dispensing position wherein a measured powder dose from the interior cavity 11 of the canister 12 is communicated to and through an aperture 23 at the narrowing end of a frustoconical dispensing tip 22 and into the drinking vessel or other container.

It should be noted that the diameter of the aperture 23 at the dispensing tip 22 is preferably smaller than a circumference of the open end of a drinking glass or fluid container to be used with the device 10. The frusto conical shape of the dispensing tip 22 narrowing toward and at the aperture 23 is particularly preferred as it has been shown to avoid spillage occurring where the aperture 23 is sized equal to the first end of the tip 22. Further, the frustoconical shape, and narrowing at the aperture 23, allows the user the ability to choose a glass or container of equal or preferably larger size than the aperture 23 by using the aperture 23 diameter as a measuring component.

A lid 19 may be provided for engagement at the opening to the interior cavity 11 at a first end of the cannister. The lid 19 would be configured for a removable engagement to the sidewall 13 defining the opening at this first end. Alternatively, as noted, a pill dispenser 20 can be configured to serve the dual functions of providing an interior cavity for storing additional medications or supplements therein, and providing an engageable lid for the opening to the interior cavity 11 at the first end of canister 12 which when removed allows for a filling or replenishment of the powder within the internal cavity 11 of the cannister 12.

Also shown in FIG. 1-2, a cap 52 may be provided in a configuration rendering it employable for a removable engagement with a second end of the cannister 12. So engaged the cap 52 will cover over the aperture 23 at the narrow end of the circumference of the dispensing tip 22 to protect it and keep it clean during transportation and storage.

FIG. 2A depicts a mode of the device 10 similar to that of FIGS. 1-2 but wherein the actuator is provided by a rotationally engaged trigger 31 operatively connected to rotate the rotationally engaged dispensing housing 18. As with the actuator of FIG. 1, a biasing member such as a spring 37 is engaged with either the trigger 31 or the dispensing housing 18, or the connecting member 39, to bias the trigger to a default projecting position, extending away from the sidewall 13 of the device 10.

In this default position of the trigger 31 and actuator of FIGS. 2A-2B, or the button 16 and actuator of FIG. 1, the dispensing housing 18 is held in a first position, such as in FIG. 2, wherein a first opening 41 or inlet aperture to a measuring chamber 43 communicates with a passage leading to the interior cavity 11. In this first position, gravity will cause powder to communicate from the interior cavity 11 to fill the measuring chamber 43, and an exit opening 49 or exit aperture, at the opposite end of the measuring chamber 43 is sealed against a wall of a recess holding the measuring chamber 43.

Activation of the actuator, overcomes the biasing force of the biasing member or spring 37, and rotates the measuring chamber 43, such that the exit opening 49 or exit aperture on the other end of the measuring chamber 43 aligns with an opening in the wall of the recess, wherein the powder under the force of gravity, will vacate the measuring chamber 43 and drop through the aperture 23 into a container thereunder. With the dispensing housing 18 and internal measuring chamber 43 in this second position, as can be surmised from the drawings by those skilled in the art, the first opening 41 or inlet aperture, is sealed from communication with the interior cavity 11.

FIG. 2B depicts an enlargement of the actuator shown in FIG. 2A showing the trigger 31 and engaged connecting member 39 rotationally engaged between the trigger 31 and the cylindrical dispensing housing 18. As shown, the trigger 31 is spaced from the silicone sleeve 14 and moving away therefrom to actuate the dispensing housing 18 to rotate from the first position shown in FIG. 2, toward the second position wherein the exit opening 49 of the measuring chamber 43, will align with a gap 51 in the wall of the cavity hosting the measuring chamber 18 defining the egress slot 32. In the second position, powder within the measuring chamber 18 is communicable to and through the aperture 23 in the dispensing tip 22.

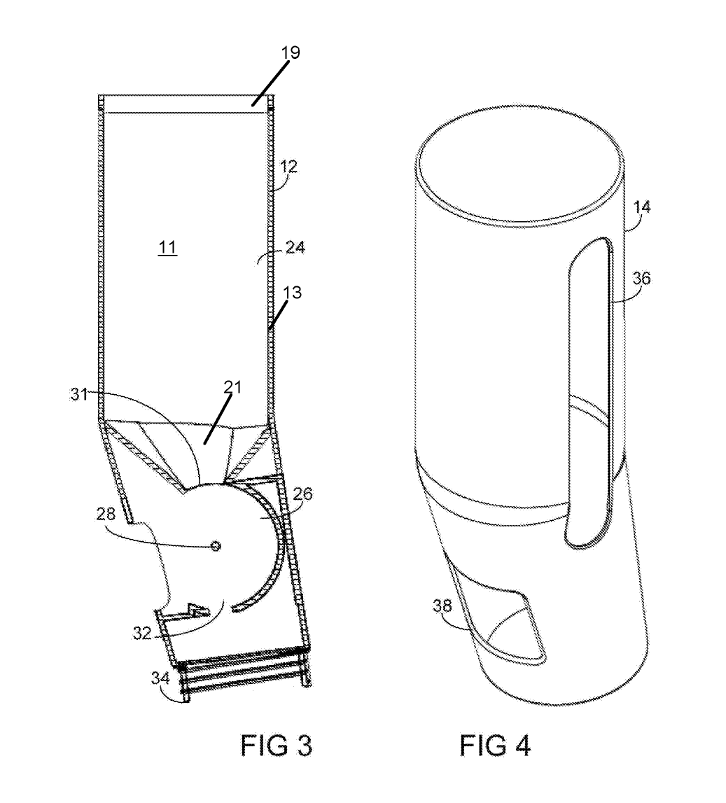

As depicted in FIG. 3, the canister 12 has a substantially tubular configuration formed by the sidewall 12 defining the internal cavity 11. In a preferred mode, an angled bend and subsequent narrowing of the diameter of a passage 21 communicating between the internal cavity 11, and the first opening 11 of the measuring cavity 43, serves to direct and funnel powder from the internal cavity 11, through an ingress slot 31, into the measuring chamber 43 which is sized to hold a measured volume of communicated powder. The internal cavity 11 preferably should be configured to hold between 5 and 20 cubic inches of powder in a preferred mode of the device 10 which has shown to allow for a number of sequential fillings of the measuring chamber 43.

The exterior circumference of the dispensing housing 18 should be sized to tightly fit and seal against the wall surrounding the dispensing housing 18, and thereby seal the first opening 41, or inlet aperture, from any powder communication from the internal cavity 11, when the dispensing housing 18 is rotated to the second position, to communicate the volume of powder within the measuring cavity 43, through an with egress slot 32 or opening and to the dispensing tip 22. The dispensing tip 22 in the noted removable engagement to the second end of the cannister 12.

The canister 12 additionally contains an access hole for the button 16 and an axle 38 for rotation of the dispensing housing 18 thereon, if not fully supported by the wall surrounding the circumference of the dispensing housing 18. Graduated marks may be provided which may be molded, painted or adhered to the canister 12 can additionally be employed to display the volume of contained powder. Sealing features within the canister 12 should be placed at the distal end of the passage 21, and at the egress slot 32, to prevent powder loss as the dispensing housing 18 rotates and while being carried or transported if required.

As seen in FIG. 4, the dimensions of the silicone sleeve 14 are contoured to a complimentary fit tightly around the exterior surface of the complimentary shaped canister 12, and additionally contains a viewing portal 36 and a button portals 38.

An example of an actuator formed as a button 16 is shown in FIG. 5, and includes an actuation face 40, two opposing gear racks 42, and a set of stabilizing legs 44. The button 16 or the canister 12 should contain a biasing member such as a spring 37 (FIG. 2B), to ensure that after actuation, the button 16, or trigger 31 is biased to return to its original projecting position. This biasing member can be one or a combination of biasing members from a group including compression springs, tension springs, torsion springs, disk springs or flexures.

The dispensing housing 18, as seen in FIG. 6 is cylindrical in shape and designed to rotate within a surrounding wall formed within a mid section of the canister 12 and about a shaft 28 if included. A rack or gear 48 on each side of dispensing housing 18 mates with the complimentary gear racks 42 extending from the button 16 if employed for the actuator.

A first opening 41 allows powder to fall under the force of gravity into the measuring chamber 43 within the dispensing housing 18. Rotating the dispensing housing 18 clockwise until its chamber exit opening 49 or exit aperture aligns with the egress slot 32 of the canister 12 allows only the specific volume of powder, equal to the size of the measuring chamber 43 of the dispensing housing 18, to fall and exit the canister 12.

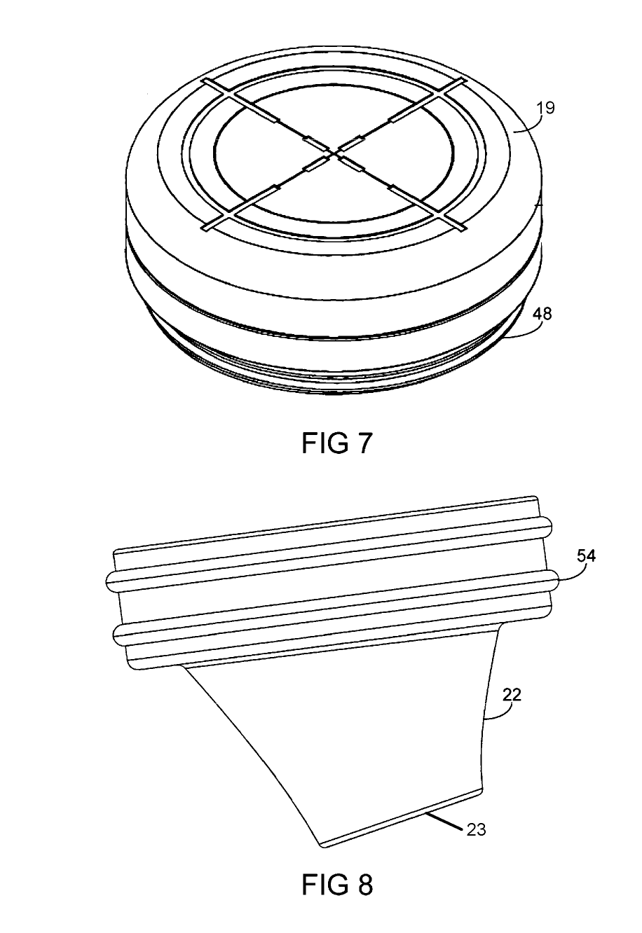

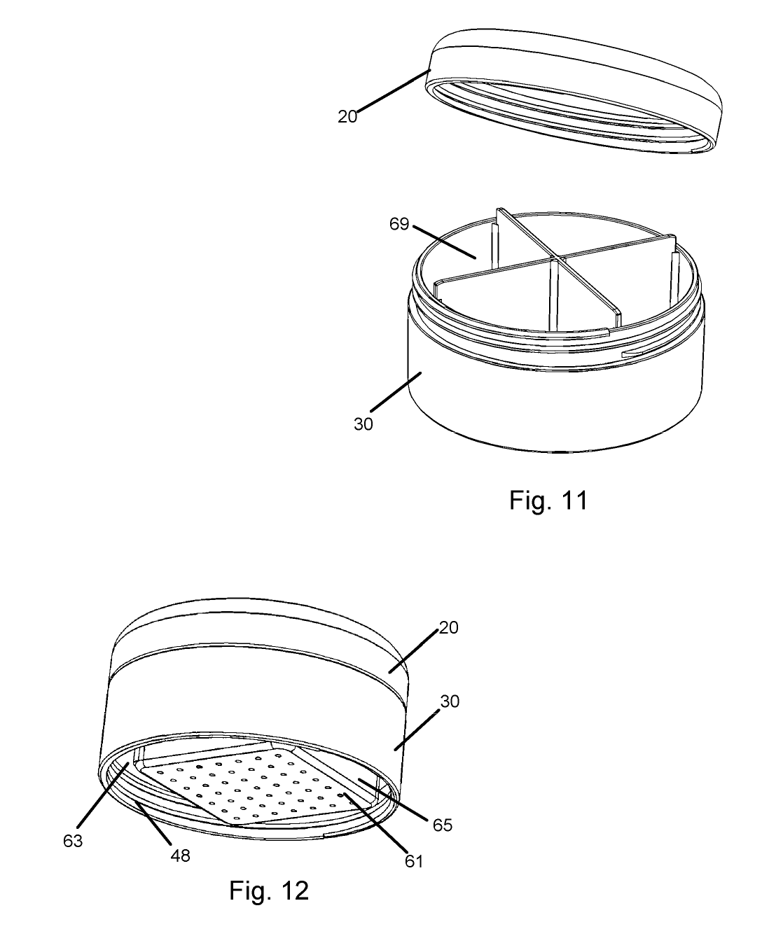

FIG. 7 shows a cover 19 removably engageable to the first end of the cannister 12 if the pill container 20 is not employed. The pill container 20 shown in FIG. 11 can be used and is preferably segmented and contains internal and removable cavities divided by removable separators to organize several different types of pills.

Shown in FIG. 8, the frustoconical dispensing tip 22, which is curved and directs powder from the proximal end of the canister into the bottle or container of choice. One end of the dispensing tip 22 includes threads to tightly and securely mate to the complimentary matching threads of the canister 12. Additionally, the o-rings 54 seals of the dispensing tip affixes the cap 52 to the reminder of the device 10. The diameter of the aperture 23 of the dispensing tip 22 should be between 0.25 and 3 inches. Additionally the dispensing tip 22 should be curved in such a way as shown, to increase powder flow and prevent blockages.

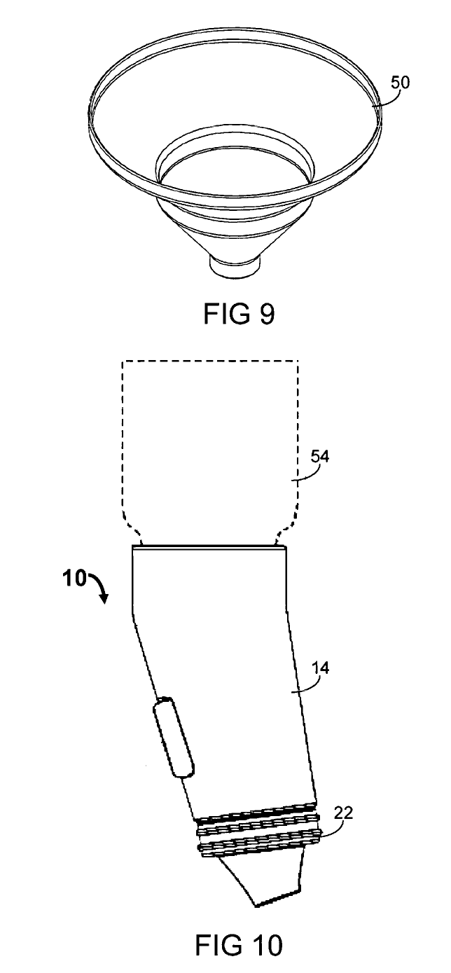

Shown in FIG. 9 is a funnel designed with the larger diameter end sized to fit within the first end opening communicating with the internal cavity 11 of the cannister 12, for easy powder loading. To employ the device 10 herein, the user loads powder from its original container, with or without the aid of the funnel 50 into the canister 12. The lid or the pill container is then placed securely on the filled canister 12 and the cap 52 is removed. Since the inlet slot 46 allows powder to fall therethrough under the force of gravity, the dispensing housing 18 is filled by default.

Pressing the button 16 causes the dispensing housing 18 to rotate clockwise until its chamber outlet slot 47 aligns with the egress slot 32 to allow only the specific volume of powder, equal to the size of the inner cavity, to communicate from the dispensing cavity 18 and into the user's bottle or container of choice.

In another particularly preferred mode of the device 10, shown in FIG. 10, the first end of the canister 12 has a small internal cavity 11 not sized to contain and store powder. However, the first end opening communicating with the internal cavity 11, is adapted to removably engage with one or a plurality of commercial product containers 54 used by different manufactures to ship and display their product. As such, in this mode, where canister container volume is unimportant, the internal cavity 11 can be minimized for increased transportability.

As noted above, FIG. 11 shows a larger and exploded view of the optional secondary container formed as a segmented pill or tablet holder configured with segmented cavities 69 to be employed in place of the engageable lid of FIG. 7.

Finally, FIG. 12 depicts a perspective view of a perforated holding cavity 61. This holding cavity 61, is removably engageable to the surface 63 of a front wall which communicates with the internal cavity 11 of either the lid of FIG. 7, or the secondary container shown in FIG. 11, and FIG. 2. The perforated holding cavity 61 is adapted for positioning of a desiccant 62 therein which once so positioned, will help maintain the powder within the internal cavity 11 dry. One means of removably engagement of the holding cavity 61 to the surface 63 of the frontwall can be frictional engagement of the sidewalls 65 to projections extending from the surface 63 of the frontwall.

As noted, any of the different configurations and components herein can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A portable storage and dispensing apparatus, comprising:
a sidewall defining a cannister, said cannister having a first end, a mid portion, and a second end;
an interior cavity at said first end of said cannister, said interior cavity in communication with a said mid portion;
a dispensing housing having an exterior surface, said dispensing housing rotationally positioned within said housing in said mid portion;
said dispensing housing having a measuring cavity therein;
an inlet aperture communicating through said exterior surface of said dispensing housing to said measuring cavity;
an outlet aperture communicating through said exterior surface of said dispensing housing to said measuring cavity;
said dispensing housing having a first position wherein said inlet aperture is in a communication with said interior cavity;
said dispensing housing having a second position wherein said inlet aperture is blocked from said communication with said interior cavity, and said outlet aperture is in a communication with an exit aperture at said second end of said of said housing;
an actuator for moving said dispensing housing from said first position to said second position; and
wherein a volume of powder within said interior cavity fills said measuring cavity with said dispensing housing in said first position, and said volume of powder is dispensed from said measuring cavity through said exit aperture with said dispensing housing in said second position.

2. The portable storage and dispensing apparatus of claim 1, wherein said actuator includes a depressible trigger or button extending from an exterior of said sidewall; and
a biasing member connected to said actuator to hold said dispensing housing in said first position until said trigger or button is depressed.

3. The portable storage and dispensing apparatus of claim 1, wherein said exit aperture is located in a second end of a dispensing tip;
a first end of said dispensing tip opposite said second end, configured for a removable engagement to said second end of said cannister; and
said dispensing tip being frusto conical in shape and having a larger cross section at said first end which narrows to a smaller cross section at said second end.

4. The portable storage and dispensing apparatus of claim 2, wherein said exit aperture is located in a second end of a dispensing tip;
a first end of said dispensing tip opposite said second end, configured for a removable engagement to said second end of said cannister; and
said dispensing tip being frustoconical in shape and having a larger cross section at said first end which narrows to a smaller cross section at said second end.

5. The portable storage and dispensing apparatus of claim 3, wherein said exit aperture is located in a second end of a dispensing tip;
a first end of said dispensing tip opposite said second end, configured for a removable engagement to said second end of said cannister; and
said dispensing tip being frustoconical in shape and having a larger cross section at said first end which narrows to a smaller cross section at said second end.

6. The portable storage and dispensing apparatus of claim 1, wherein said first end of said cannister is configured for a sealed engagement with one end of a powder container, and whereby said interior cavity is refillable by engagement of a said powder container having powder therein, to said first end of said cannister.

7. The portable storage and dispensing apparatus of claim 2, wherein said first end of said cannister is configured for a sealed engagement with one end of a powder container, and whereby said interior cavity is refillable by engagement of a said powder container having powder therein, to said first end of said cannister.

8. The portable storage and dispensing apparatus of claim 3, wherein said first end of said cannister is configured for a sealed engagement with one end of a powder container, and whereby said interior cavity is refillable by engagement of a said powder container having powder therein, to said first end of said cannister.

9. The portable storage and dispensing apparatus of claim 4, wherein said first end of said cannister is configured for a sealed engagement with one end of a powder container, and whereby said interior cavity is refillable by engagement of a said powder container having powder therein, to said first end of said cannister.

10. The portable storage and dispensing apparatus of claim 5, wherein said first end of said cannister is configured for a sealed engagement with one end of a powder container, and whereby said interior cavity is refillable by engagement of a said powder container having powder therein, to said first end of said cannister.

11. The portable storage and dispensing apparatus of claim 1 additionally comprising:
said first end of said housing configured for a removable engagement of a secondary container thereon;
said secondary container in said removable engagement, having a front wall at a first side forming a seal with an opening at said first end of said cannister communicating into said storage cavity;
said secondary container having a removable lid on a second side opposite said first side; and
said secondary container having an internal storage area adapted for positioning of food supplements therein.

12. The portable storage and dispensing apparatus of claim 2 additionally comprising:
said first end of said housing configured for a removable engagement of a secondary container thereon;
said secondary container in said removable engagement, having a front wall at a first side forming a seal with an opening at said first end of said cannister communicating into said storage cavity;
said secondary container having a removable lid on a second side opposite said first side; and
said secondary container having an internal storage area adapted for positioning of food supplements therein.

13. The portable storage and dispensing apparatus of claim 3 additionally comprising:
said first end of said housing configured for a removable engagement of a secondary container thereon;
said secondary container in said removable engagement, having a front wall at a first side forming a seal with an opening at said first end of said cannister communicating into said storage cavity;
said secondary container having a removable lid on a second side opposite said first side; and
said secondary container having an internal storage area adapted for positioning of food supplements therein.

14. The portable storage and dispensing apparatus of claim 4 additionally comprising:
said first end of said housing configured for a removable engagement of a secondary container thereon;
said secondary container in said removable engagement, having a front wall at a first side forming a seal with an opening at said first end of said cannister communicating into said storage cavity;
said secondary container having a removable lid on a second side opposite said first side; and
said secondary container having an internal storage area adapted for positioning of food supplements therein.

15. The portable storage and dispensing apparatus of claim 5 additionally comprising:
said first end of said housing configured for a removable engagement of a secondary container thereon;
said secondary container in said removable engagement, having a frontwall at a first side forming a seal with an opening at said first end of said cannister communicating into said storage cavity;
said secondary container having a removable lid on a second side opposite said first side; and
said secondary container having an internal storage area adapted for positioning of food supplements therein.

16. The portable storage and dispensing apparatus of claim 6 additionally comprising:
said first end of said housing configured for a removable engagement of a secondary container thereon;
said secondary container in said removable engagement, having a frontwall 63 at a first side forming a seal with an opening at said first end of said cannister communicating into said storage cavity;
said secondary container having a removable lid on a second side opposite said first side; and
said secondary container having an internal storage area adapted for positioning of food supplements therein.

17. The portable storage and dispensing apparatus of claim 1 additionally comprising:
a silicone sleeve surrounding said cannister in a contact with an exterior surface thereof.

18. The portable storage and dispensing apparatus of claim 7 additionally comprising:
a silicone sleeve surrounding said cannister in a contact with an exterior surface thereof.

19. The portable storage and dispensing apparatus of claim 16 additionally comprising:
a silicone sleeve surrounding said cannister in a contact with an exterior surface thereof.
